(19) United States
(12) Patent Application Publication
(10) Pub. No.: US 2019/0028796 A1
(43) Pub. Date: Jan. 24, 2019

(54) Headphone Assembly with Removable and Exchangeable Decoration Tags or Tabs

(71) Applicants: Larry Tang, Pacific Grove, CA (US); Peter Fohsien Tang, Pacific Grove, CA (US); Alexander Fuwas Tang, Pacific Grove, CA (US)

(72) Inventors: Larry Tang, Pacific Grove, CA (US); Peter Fohsien Tang, Pacific Grove, CA (US); Alexander Fuwas Tang, Pacific Grove, CA (US)

(21) Appl. No.: 15/657,585

(22) Filed: Jul. 24, 2017

(51) Int. Cl. H04R 1/10

(52) U.S. Cl. CPC H04R 1/1058; H04R 1/1091; H04R 1/1008

(57) ABSTRACT

A headphone assembly with earpiece connections at their proximal ends to opposite ends of a headband, with one or both earpieces having releasably securable caps at their distal ends overlying a chamber housing audio processing unit components and circuitry, and with at least one of the caps displaying or imprinted with names, pictures, colors or patterns selected by a wearer of the headphone assembly.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

### Field of the Invention

This invention relates to an improved headphone assembly allowing for its display of selected names, pictures, colors or patterns in a manner of modifying a decorative appearance in a headphone assembly presentation.

### Description of the Related Art

Were a visitor to walk into a sports outdoor stadium or indoor arena during game time, he/she might be taken aback by the large number of home town fans there wearing hats, jackets, shirts or blouses bearing the names, colors and/or patterns of their beloved team. In locales where these games are additionally being broadcast, furthermore, the visitor would probably see a great many fans employing earbuds plugged into their smartphones or other electronic devices listening to announcers commenting as to what was going on before them. Multiplying this by all the different home teams in that same city or arena (in the United States, in Chicago, for example, there are the Cubs and the White Sox in Baseball, the Bears in Football, the Bulls in Basketball, and the Blackhawks in Hockey; or in Boston, with the Red Sox in Baseball, the Patriots in Football, the Celtics in Basketball, and the Bruins in Hockey; or in New York, with the Yankees and Mets in Baseball, the Giants and the Jets in Football, the Knicks and Nets in Basketball, and the Rangers, Islanders and Devils in Hockey) the cost for purchasing articles of clothing that go along with these team allegiances are not inexpensive. And it goes without saying that the cost for so outfitting a fan's children this way continues to increase with time as the child gets older and thus needs increasingly larger sizes. Going from season sport to season sport an adult's expenditure for these associations increases as well—especially at those times where teams decide to modernize the look of their present uniforms, when changing from one format to another.

As will be understood from a reading of my Ser. No. 15/202,645 Application “Removable And Exchangeable Decoration Tabs And Tags For Earbuds Or Earphones” (Publication No. US-2017-0026738), the invention described therein, in one respect, strove to regulate those costs somewhat by providing a removable and exchangeable decorative applique (for example, a tab or a tag) for the earbuds and earphones used with the smartphones or other electronic devices—and, by permitting switching from one team's affiliation and association to another's whether in the same sport or not, whether in the same city or not, and whether in the same country or not. Thus, a New York Yankees Baseball fan, residing in Miami, Fla., for example, could switch his Yankee earbud or earphone decorative applique to a Dallas Cowboys one for Football, to a Chicago Bulls one for Basketball, and to a Los Angeles Kings one for Hockey—and even to a Swedish one for Soccer, and to a New Zealander one for Rugby; or to just exchange or trade one for another; and all without having to purchase additional earbuds or earphones.

As will also be apparent, the removability and exchangability of such applique tab or tag could also be utilized in announcing one's grade school, high school or college name association, another one's affiliated organizational logo, or one's own personal name designation—or just to coordinate with the clothing he or she might be wearing at the time. In those manners, earbuds and earphones could be sold with those individual adornments already in place, along with individual packagings containing different color arrangements, patterns or designs, or tabs or tags of favorite entertainment entities (such as bands, movie stars, vocalists and television characters), or world celebrities, whatever a buying public might be interested in. An exchanging or trading of such individual tags or tabs could also easily follow between users of correspondingly constructed earbuds or earphones.

U.S. Pat. No. 7,080,764, although not directly in point, describe the dissatisfaction of many motorists having a conventional “EZ Pass” toll gate type transmitter sticking out unceremoniously on the inside of their vehicle's windshield—and proffers the inclusion of a more decorous compartment housing in which to carry it, whose substance and appearance are consistent with the brand and/or model of the vehicle and with its interior's display. So, too, one might wish to avoid the use of “sticker appliques” of these types of allegiances on the more expensive headphones typically worn in the enjoyment of recorded music, or with a higher quality listening arrangement than an earbud or earphone assembly (and, whether using it in a sports outdoor stadium, in an indoor arena environment or just at home; although sticker appliques or tabs could still be used if desired.

### OBJECTS OF THE INVENTION

It is an object of the present invention, to continue these kinds of display allegiances and affiliations to personal headphone assembly systems—and continuing, as before, in an inexpensive manner, and not only limited to sports team preferences.

It is another object of the invention to similarly continue the ease of removing and exchanging the decoration tabs and tags of the Ser. No. 15/202,645 Application in a simple and easily accomplishable manner.

### SUMMARY OF THE INVENTION

As will become clear from the following description, the headphone assembly of the present invention includes a headband having a left end and an opposing right end, along with a pair of earpieces, each having a proximal side coupled to one of the headband ends and a distal side. The assembly also includes at least one of the earpieces housing audio processing unit components and circuitry within a chamber for providing sound to a wearer of the assembly. Additionally, at least one of the first and second earpieces includes a cap at the distal side thereof overlying the chamber and matingly connected therewith for releasably securing the cap over the chamber. In accordance with the teachings of the invention, the assembly includes an upper surface of at least one of the caps in displaying one of a designated class which includes names, pictures, colors and/or patterns as selected for display by the wearer of the headphone assembly.

In a preferred embodiment of the invention, the designated class is imprinted, rather than being merely displayed as an applique, on the upper surface of the cap—with alternative versions of the invention including the display/imprinting of the designated class either “on” one or on both of the caps as desired. To facilitate a remove-and-exchange ability of the imprinted cap, a latch arrangement is included on the cap or caps for releasing the cap or caps from its/their mated connection overlying the sound chamber(s)and its housed audio processing unit components and circuitry.

As will be understood—and as most probably utilized—the designated class imprinted on the upper surface of the caps of both earpieces may be that of a sports team name, a sports team logo, an entity, organization or school name, or an entertainment or world celebrity.

And, as will be further understood, the cap or caps may still continue to display, instead, these allegiances and affiliations with sticker, peel-off type appliques, if desired.

### BRIEF DESCRIPTION OF THE DRAWINGS

These and other features of the present invention will be more clearly understood from a consideration of the following description, taken in connection with the accompanying drawings in which:

FIGS. 1-4 are alternative views of a headphone assembly constructed in accordance with the teachings of the invention;

FIGS. 5-6 are perspective views of the earphone assembly of the invention, as t would appear with the cap of the invention and the audio processing unit components and circuitry removed;

FIGS. 7-10 are helpful in an understanding of the manner by which the overlying cap with its displayed/imprinted designated class of allegiances or affiliations may be releasably secured atop an underlying earpiece chamber; and

FIGS. 11-12 illustrate perspective views of the utilization of the headphone assembly of the invention with the cap in position atop the earpiece chamber.

### DETAILED DESCRIPTION OF THE INVENTION

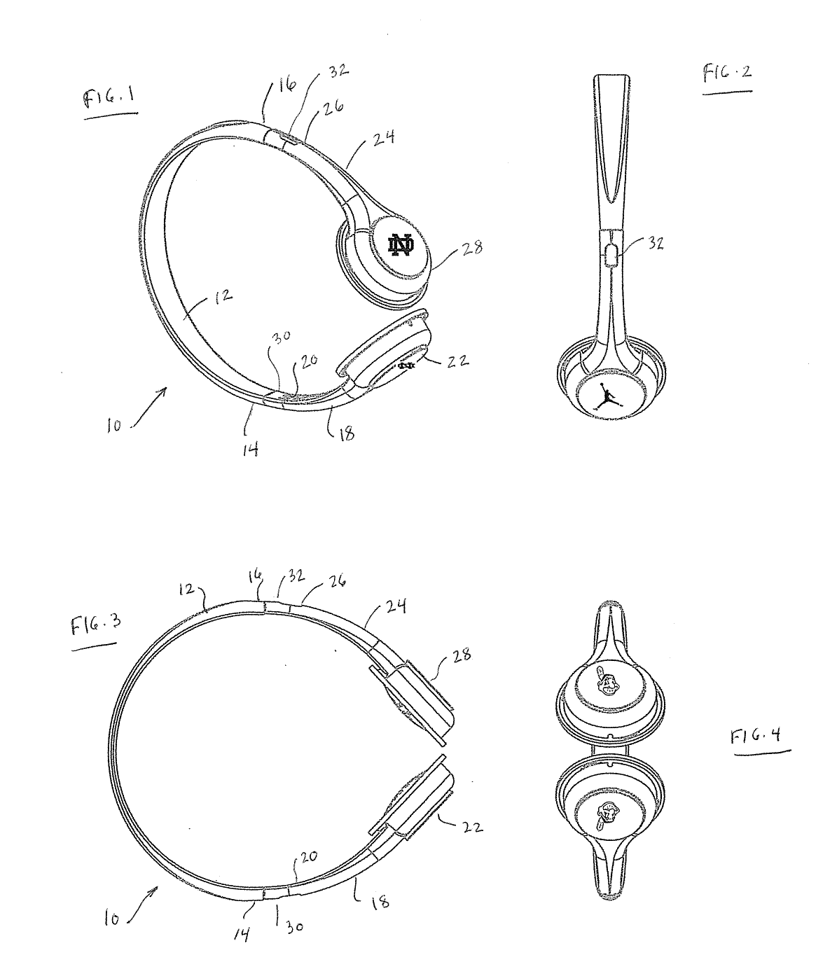

The headphone assembly of the invention is shown at 10 in FIGS. 1-4, as including a headband 12 having a left end 14 and an opposing right end 16. A first earpiece 18 includes a proximal end 20 coupled to the left end 14 of the headband 12 and a distal end 22. A second earpiece 24 similarly has a proximal end 26 coupled to the right end 16 of the headband 12, and a distal end 28. In one embodiment of the invention, the earpieces 18 and 24 are constructed so that their proximal ends 20 and 26 are respectively coupled integrally with ends 14 and 16 of the headband 12—or preferably, are removably coupled with the headband ends as indicated by the fingertip releases 30, 32 on the earpieces 18, 24 as more clearly indicated in FIGS. 1 and 3, and at 32 in FIG. 2.

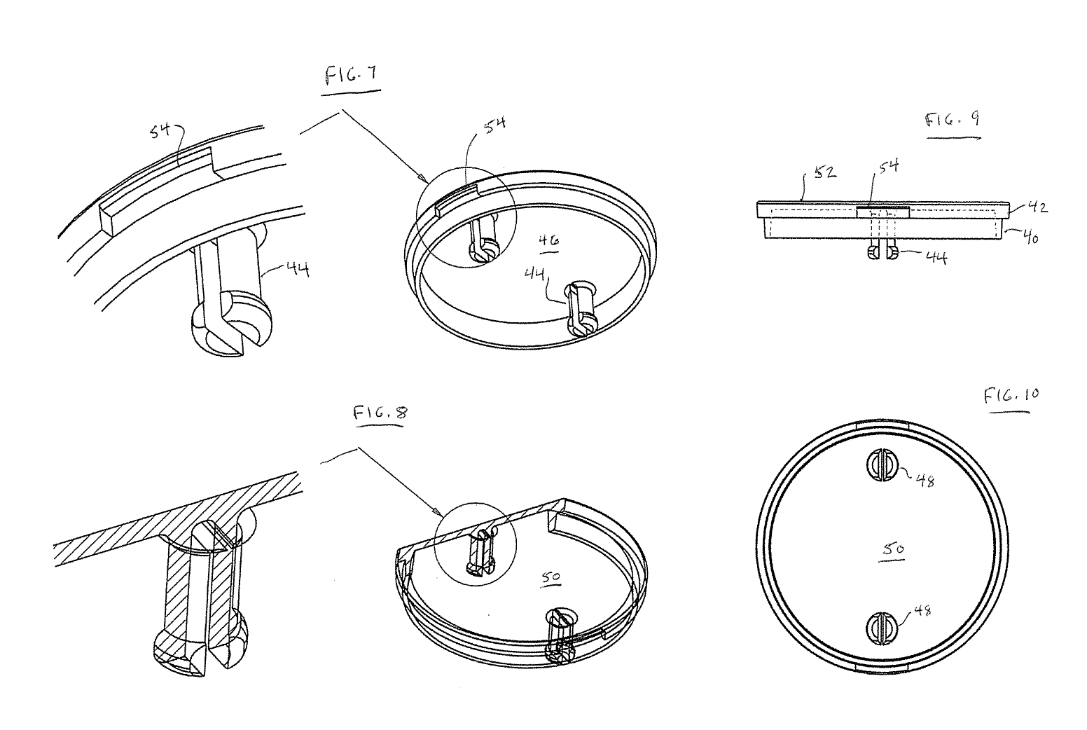

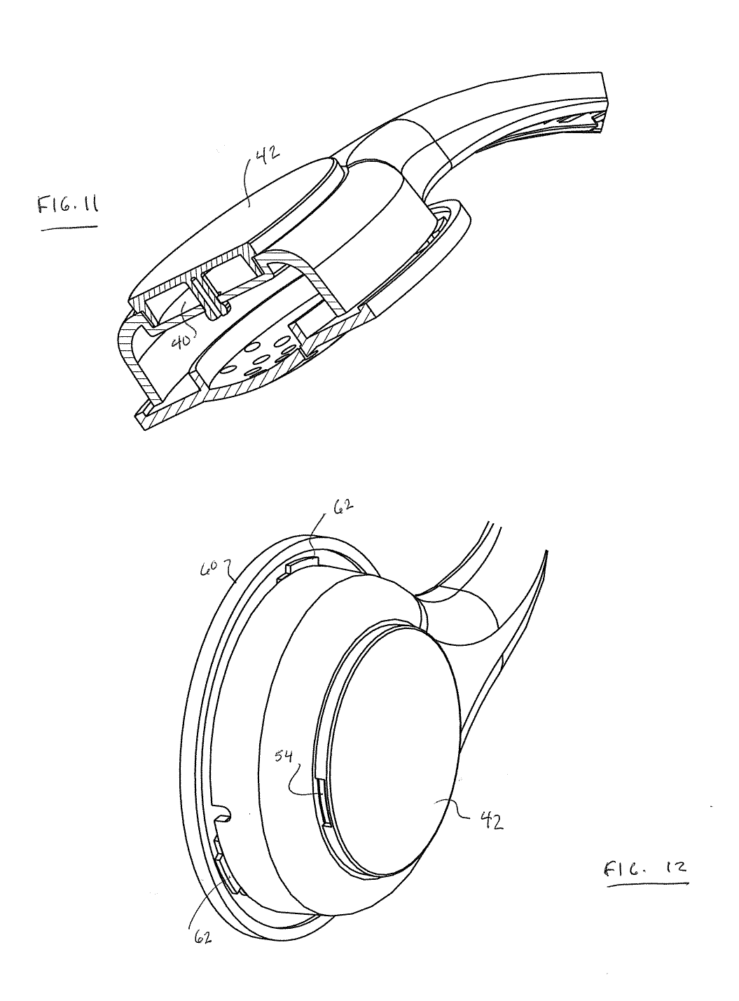

In accordance with the invention, at least one earpiece (or preferably both as intended in the Drawings), includes a chamber housing audio processing unit components and circuitry for providing sound to a wearer of the headphone assembly 10. A top view of the chamber(s) 40 is shown in FIG. 11 with the audio processing unit components and circuitry removed; and at least one of the earpieces—and preferably both earpieces 18 and 24—include a cap 42 (FIG. 12) at the distal ends 22 and 28 of the earpieces to matingly couple with the chamber(s) 40 in overlying relationship as shown in FIGS. 11 and 12. Such mated coupling can be attained in any acceptable and appropriate manner, such as with downwardly pointing, slotted posts 44, extending from the underside 46 of the cap(s) 42 (FIGS. 7 and 9), in joining with receiving receptacles 48 upwardly extending from the base 50 of the chamber 40 in FIGS. 8 and 10. The sectional views of the posts 44 and the receptacles 48 in FIGS. 7 and 8, will be understood as only one manner of coupling the cap 42 over the sound providing chamber 40.

According to the invention, each of the caps 42 are constructed to present the appearance of a designated class including names, pictures, colors and/or patterns. An upper surface 52 of the cap 42 might be constructed to receive a sticker applique displaying such an allegiance or affiliation, but preferably, the upper surface 52 is imprinted with the name, logo, picture, color and/or pattern of choice. An appropriate latch release 54 is provided on the cap 42 adjacent to the post 44 in allowing a finger-tip removal of the overlying cap 42 (or by any other operative release manner to remove the cap and allow its replacement by the wearer for that of an alternative choice). FIGS. 7 and 9 more clearly show the latch release 54 and the post 44 extending downwardly from the underside of the cap 42.

In the usage of the invention, the display on the upper surface 52 of the cap, or the imprinting of the designated class might be such as to project, for example, a sports team logo allegiance (Cleveland Indians—Baseball in FIG. 4), a school affiliation (Notre Dame in FIG. 1) and a celebrity identification (Michael Jordan Logo in FIG. 2). Political organizations, professional societies, school attendances, and a myriad number of similar associations can be selected for the upper surface of either or both caps 42 overlying the acoustic sound providing chamber 40—all easily removable through the finger latch release 54 or like removal of the cap 42 from its overlying coupling with the chamber 40—especially as an alternative manner of projecting such alliances through a removal of one earpiece and/or the other from their connection with the headband 12 via a removable de-coupling at 30 and/or 32 (FIGS. 1 and 3) and substitution therewith of another with its own informational content.

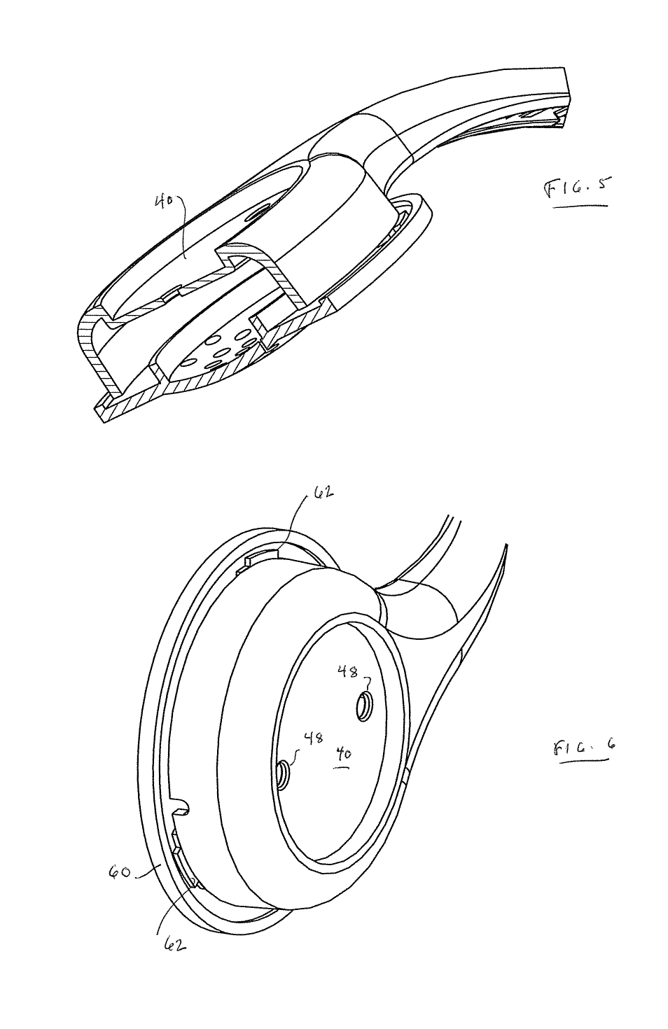

FIGS. 5 and 6 in these respects show the earpiece assembly 10 before the addition of the audio processing unit components and circuitry to the chamber 40 and its covering by the overlapping cap 42. An acoustic absorber sound screen is illustrated at 60 for the added audio enjoyment of a wearer of the assembly. A second latch 62 allows for its removal and attachment to the earpiece construction, as also shown in FIG. 12.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

We claim:

1. A headphone assembly comprising:
a headband having a left end and an opposing right end;
a first earpiece having a proximal end coupled to said left end of said headband and a distal end;
a second earpiece having a proximal end coupled to said right end of said headband and a distal end;
at least one of said first and second earpieces housing audio processing unit components and circuitry within a chamber for providing sound to a wearer of the headphone assembly;
at least one of said first and second earpieces including a cap at said distal end thereof overlying the chamber within and matingly coupled therewith for releasably securing said cap over said chamber;
and with an upper surface of the at least one of the caps displaying one of a designated class including names, pictures, colors and/or patterns as selected for display by the wearer of the headphone assembly.

2. The headphone assembly of claim 1 wherein said one of said designated class is imprinted on said upper surface of the cap of at least one of the first and second earpieces.

3. The headphone assembly of claim 1 wherein said upper surface of the cap of at least one of the first and second earpieces includes means for unlatching said cap from said underlying sound providing chamber in releasing said secured cap from mated coupling therewith.

4. The headphone assembly of claim 3 wherein each of said first and second earpieces house audio processing unit components and circuitry within a chamber for providing sound to the wearer of the headphone assembly.

5. The headphone assembly of claim 4 wherein each of said first and second earpieces include said cap at the distal end thereof respectively overlying said chambers in displaying said designated class as selected for display by the wearer of the headphone assembly.

6. The headphone assembly of claim 5 wherein the upper surface of each of said caps is imprinted with the designated class of names, pictures, colors and and/or patterns as selected for display.

7. The headphone assembly of claim 1 wherein said first and second earpieces are removably coupled to said opposing left and right ends of said headband.

8. The headphone assembly of claim 6 wherein said first and second earpieces are removably coupled to said opposing left and right ends of said headband.

9. The headphone assembly of claim 4 also including an acoustic absorber sound screen within each of said underlying sound providing chambers.

10. The headphone assembly of claim 9 wherein said acoustic absorber sound screen is positioned overlying a base of each of said underlying sound providing chambers.

11. The headphone assembly of claim 10 wherein an underside of each of said underlying sound providing chambers includes a pair of receptacles sized to releasingly secure downwardly pointing posts extending from undersides of said caps in releasably joining said caps in overlying said chambers.

12. The headphone assembly of claim 5 wherein each of said first and second earpieces includes a cap displaying a designated sports team name, sports team logo, entity, organization or school name or the name of a designated entertainment world celebrity.

13. The headphone assembly of claim 2 wherein each of said first and second earpieces includes a cap imprinted with a designated sports team name, sports team logo, entity, organization or school name or the name of a designated entertainment world celebrity.

14. The headphone assembly of claim 11 wherein each of said first and second earpieces includes a cap displaying a designated sports team name, sports team logo, entity, organization or school name or the name of a designated entertainment world celebrity.

15. The headphone assembly of claim 11 wherein each of said first and second earpieces includes a cap imprinted with a designated sports team name, sports team logo, entity, organization or school name or the name of a designated entertainment world celebrity.

16. The headphone assembly of claim 1 wherein said first and second earpieces are integrally coupled with said opposing left and right ends of said headband.

17. The headphone assembly of claim 6 wherein said first and second earpieces are integrally coupled with said opposing left and right ends of said headband.

18. The headphone assembly of claim 11 wherein said first and second earpieces are integrally coupled with said opposing left and right ends of said headband.

19. The headphone assembly of claim 12 wherein an underside of each of said underlying sound providing chambers includes a pair of receptacles sized to releasingly secure downwardly pointing posts extending from undersides of said caps in releasably joining said caps in overlying said chambers; and
wherein said pair of receptacles are positioned to releasably secure downwardly pointing posts extending from undersides of caps received by way of purchase, or by exchange from traders of caps no matter the designated class displayed thereon or whom the trader thereof might be.
